(19) United States
(12) Patent Application Publication
(10) Pub. No.: US 2017/0246925 A1
(43) Pub. Date: Aug. 31, 2017

(54) Accessory for a Trailer Hitch System

(71) Applicant: Casper Ian COETSEE, Tamboerskloof, Cape Town (ZA)

(72) Inventor: Hendrik Stephanus COETSEE, Marburg (ZA)

(21) Appl. No.: 15/512,523

(22) PCT Filed: Sep. 16, 2015
(86) PCT No.: PCT/IB2015/057127

§ 371 Date: Mar. 17, 2017

(30) Foreign Application Priority Data
Sep. 19, 2014 (ZA) 2014/06889

(51) Int. Cl. B60D 1/60; E05B 67/38; B60D 1/28

(52) U.S. Cl. CPC B60D 1/60; B60D 1/28; E05B 67/383; B60D 1/06

(57) ABSTRACT

An accessory (200) comprising a collar and a cable (214), providing for secure attachment of a trailer to a tow hitch (19) of a towing vehicle. The collar comprises a first collar member (122) and a second collar member (124) which are in the form of plates which are hingedly connected at one end and releasably locked at an opposite end around a neck (20) of the tow hitch. The accessory includes a lock (236) for locking an end of the cable (214) to the collar members (122; 124) when the collar members (122; 124) are closed around the neck (20) of the tow hitch. Prior to locking the cable (214) to the collar members (122; 124), the cable (214) is passed through a handle formation (25) of trailer coupler (19) of the trailer such that after locking the cable (214) to the collar members (122; 124), the trailer is securely attached to the tow hitch.

### FIELD OF INVENTION

This invention relates to an accessory for use with a trailer hitch system of the ball and socket type. Trailer hitch systems of this type comprise a ball-type tow hitch of a towing vehicle and a trailer coupler of a trailer which defines a socket within which a ball of the tow hitch is received for hitching the trailer to the towing vehicle.

Any reference in this specification to a “tow hitch” must be interpreted to mean a tow hitch including a ball and a neck formation having a relatively smaller cross-sectional width than a cross-sectional width of the ball.

Any reference in this specification to a “trailer coupler” must be interpreted to mean a reference to a coupler formation of a trailer, which defines a socket within which the ball of a tow hitch of a towing vehicle is received.

### SUMMARY OF THE INVENTION

According to a first aspect of the invention there is provided an accessory for a trailer hitch system comprising a tow hitch of a towing vehicle and a trailer coupler of a trailer for coupling to the tow hitch, the accessory including:

a collar which can be fitted to the neck formation of the tow hitch, the collar including a first collar member and a second collar member which are connectable to one another in a locking configuration of the collar so as to surround the neck formation, the collar members defining an aperture between them when the collar is in its locking configuration, within which the neck formation is received, a cross-sectional width of the aperture being smaller than a cross-sectional width of the ball, thereby preventing the ball from passing through the aperture, the first and second collar members having locking formations for locking the first and second collar members to one another when the collar is in its locking configuration; and

a trailer securing formation which is connected to the collar when the collar is in its locking configuration and securable to the trailer so as to secure the collar and thereby the tow hitch to the trailer.

The first and second collar members may be hingedly connected to one another in an arrangement wherein the collar members are transformable between the locked configuration of the collar and an open configuration of the collar permitting removal of the collar from the neck formation of the tow hitch.

The collar members may be in the form of plate members.

The trailer securing formation may be in the form of an elongate flexible element. More specifically, one end of the trailer securing formation may be fixedly connected to at least one of the collar members.

In a particular embodiment of the invention, the locking formations of the collar members may be in the form of locking apertures through which a locking member of a locking device can pass for locking the collar members to one another in the locking configuration of the collar. More specifically, the dimensions and location of the locking apertures may be such that when the collar is in its locking configuration, the locking apertures are in register.

The trailer securing formation may include at least one eye formation which is remote from the one end thereof which is fixedly connected to at least one of the collar members and which can be aligned with the locking apertures of the collar members when the collar is in its locking configuration, thereby permitting the locking formation of a locking device to pass through the locking apertures of the collar members and the eye formation of the trailer securing formation thereby locking the trailer securing formation to the collar members.

The trailer securing formation may be in the form of a chain including loop chain links wherein the links each constitute a particular one of the eye formations.

The accessory may include a locking device such as a padlock for locking the chain to the collar members.

In another embodiment of the invention, the locking formations of the collar members may be in the form of locking apertures through which a remote part of the trailer securing formation which is remote from the one end thereof which is fixedly connected to at least one of the collar members, can pass, the dimensions and location of the locking apertures being such that when the collar is in its locking configuration, the locking apertures are in register.

The accessory may include a two-part locking device, wherein a first part of the locking device is fixedly connected to an end of the remote part of the trailer securing formation and a second part of the locking device is releasably lockable to the first part of the locking device when the trailer securing formation extends through the locking apertures of the collar members.

### BRIEF DESCRIPTION OF THE DRAWINGS

Further features of the invention are described hereinafter by way of a non-limiting example of the invention, with reference to and as illustrated in the accompanying diagrammatic drawings. In the drawings:

FIG. 1 shows a three-dimensional view of an accessory for a trailer hitch system in accordance with the invention, wherein the collar is in a locking configuration;

FIG. 2 shows a three-dimensional view of the accessory of FIG. 1, wherein the collar is in an open configuration;

FIG. 3 shows a three-dimensional view of the accessory of FIG. 1, illustrating the manner in which the collar members of the collar are fitted to the neck formation of a hitch of a towing vehicle;

FIG. 4 shows a three-dimensional view of the accessory of FIG. 1, illustrating the manner in which the accessory is locked to the neck formation of a tow hitch; and

FIG. 5 shows a three-dimensional view of the accessory of FIG. 1, fitted and locked to a tow hitch of a towing vehicle and secured to a trailer coupler hitched to the tow hitch;

FIG. 6 shows a three-dimensional view of another embodiment of an accessory for a trailer hitch system in accordance with the invention, wherein the collar is in an open configuration;

FIG. 7 shows a three-dimensional view of the accessory of FIG. 6, illustrating the manner in which the accessory is locked to the neck formation of a tow hitch;

FIG. 8 shows a three-dimensional view of yet another embodiment from an accessory fro a trailer, in accordance with the invention, wherein the collar is in an open configuration;

FIG. 9 shows a tree-dimensional view of the accessory of FIG. 8, illustrating the manner in which the accessory is locked to a tow hitch; and

FIG. 10 shows a three-dimensional view of the accessory of FIG. 8, fitted and locked to a tow hitch of a towing vehicle and secured to a trailer coupler hitched to the tow hitch.

### DETAILED DESCRIPTION OF THE DRAWINGS

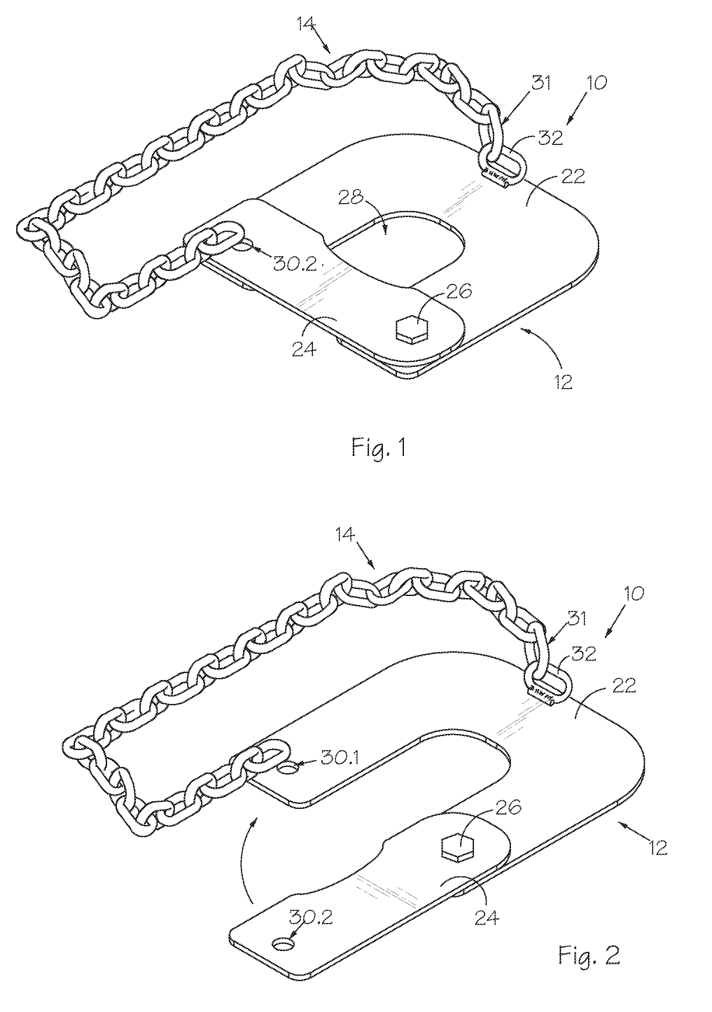

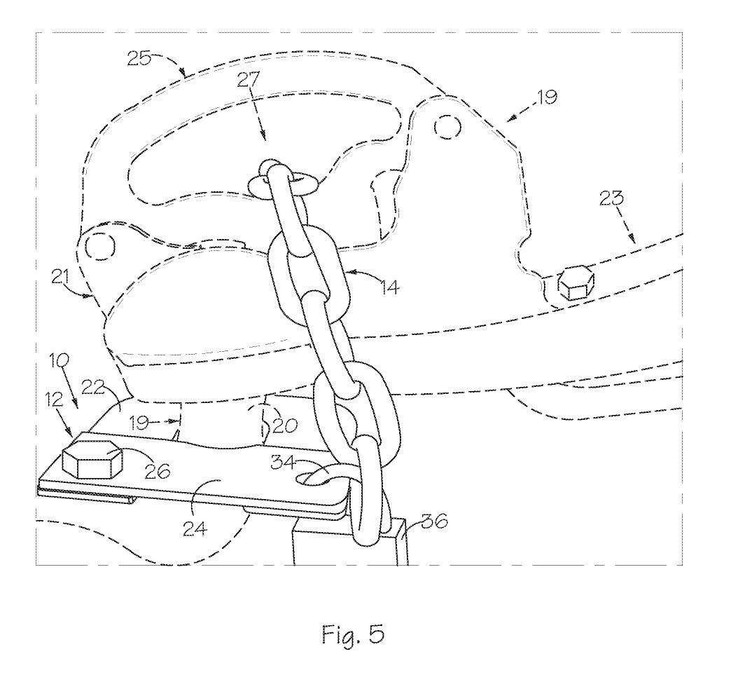

With reference to FIGS. 1-5 of the drawings, an accessory for a trailer hitch system in accordance with the invention, is designated generally by the reference numeral 10. The accessory 10 comprises, broadly, a collar 12 and a trailer securing formation in the form of a chain 14. The accessory 10 is specifically adapted for use with a trailer hitch system comprising a tow hitch 17 of a towing vehicle and a trailer coupler 19 of a trailer. In use, the accessory provides for secure attachment of a trailer to a tow hitch of the towing vehicle thereby serving as a safety and anti-theft device.

The tow hitch of the towing vehicle is of a known conventional type including a tow mount which is mounted to the towing vehicle, a ball 18 and a neck formation 20 which has a relatively smaller cross-sectional width than a cross-sectional width of the ball and which extends between the ball and the tow mount. The trailer coupler is of a known conventional type is located at a distal end of a trailer 23 and which includes a handle 25 of the type defining an aperture 27 for a hand grip. The trailer coupler defines a socket within which the ball 18 is received in an arrangement permitting articulation of the trailer coupler relative to the tow hitch.

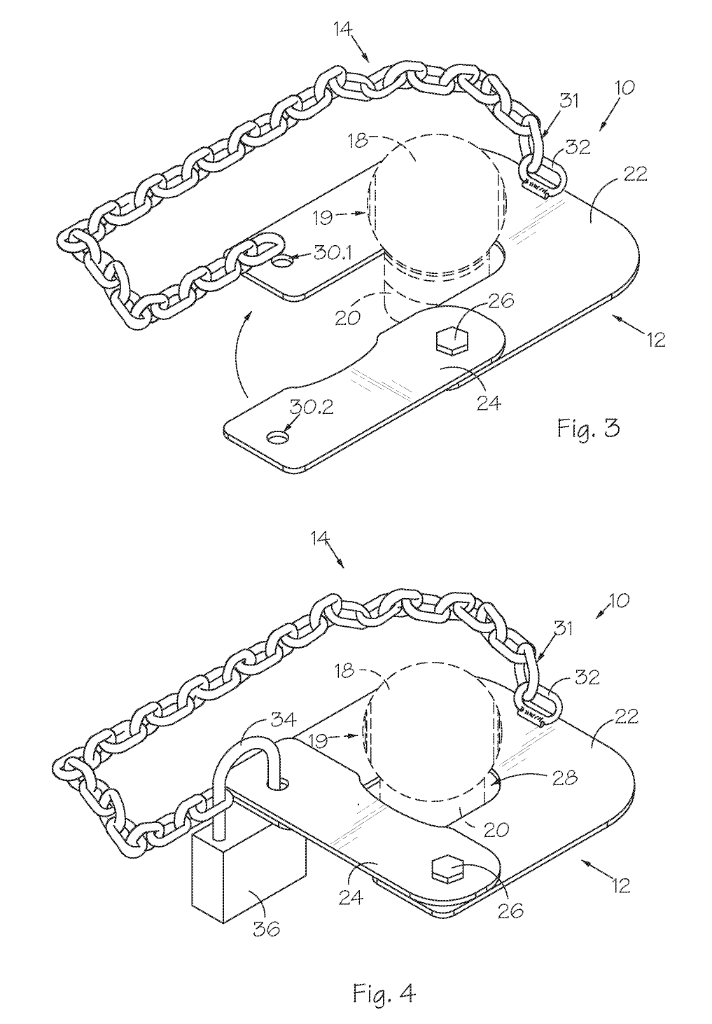

The collar 12 comprises two parts, a first collar member 22 and a second collar member 24 which are hingedly connected to one another so as to be displaceable between an open configuration of the collar (as is shown in FIGS. 2 and 3) and a closed locking configuration of the collar (as shown in FIGS. 1 and 4). The first collar member is in the form of a metal plate having a U-shaped configuration when viewed in plan view, while the second collar member 24 is in the form of an elongate generally straight metal plate. The collar members 22 and 24 are hingedly connected to one another by means of a hinge pin 26, the collar members together defining an aperture 28 within which the neck formation 20 of the towing formation is received when the collar is in its locking configuration. The cross-sectional width of the aperture 28 is smaller than the cross-sectional width of the ball thereby preventing the ball from passing through the aperture when the collar is in its locking configuration.

The collar members 22, 24 have locking formations in the form of locking apertures 30.1, 30.2, respectively, which are in register when the collar is in its locking configuration.

The chain 14 comprises a number of oval-shaped links which provide eye formations. One end 31 of the chain 14 is fixedly connected to the collar member 22 via an eye formation 32.

In use, in order to provide for secure attachment of the trailer coupler 19 to the tow hitch 17 of a towing vehicle, the collar member 22 is initially fitted to the neck formation 20 of the tow hitch when the collar is in its open configuration. The collar member 24 is then hingedly displaced relative to the collar member 22 in order to displace the collar into its locking configuration wherein the locking apertures 30.1, 30.2 are in register. In the locking configuration, the collar is securely fitted to the neck formation 22, with the neck formation being captured within the aperture 28. The chain 14 is looped through the aperture 27 of the handle 25 of the trailer coupler and with the chain pulled taut, a shackle 34 of a padlock 36 is passed through a link of the chain and the two locking apertures 30.1 and 30.2 thereby locking the chain in a taut configuration of the chain, and the collar members to one another. In this manner, the collar is locked to the neck formation 20 of the tow hitch. With the collar securely fitted and locked to the neck 20 of the towing formation and the chain 14 extending tautly through the handle, secure attachment of the trailer to the tow hitch of the towing vehicle is provided thereby serving as a deterrent to theft of the trailer and also as a safety feature resisting unintended disconnection of the trailer from the tow hitch of the towing vehicle.

The invention extends to a kit including the accessory 10 and the padlock 36 as described hereinabove.

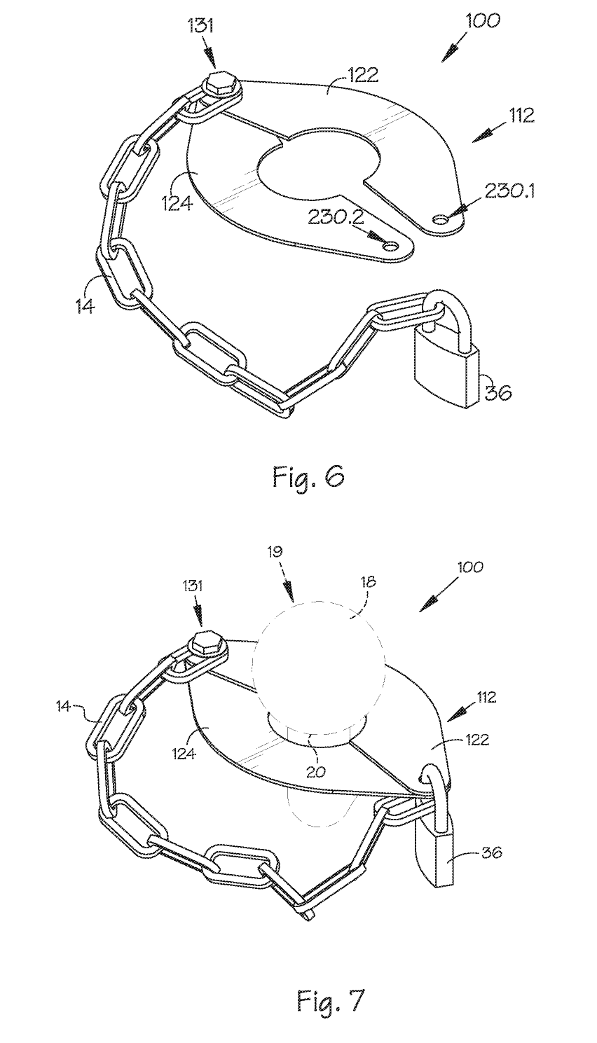

With reference to FIGS. 6 and 7 of the drawings, another embodiment of an accessory is designated by the reference numeral 100. The accessory 100 is similar to the accessory 10 with the only difference being the shapes of the collar members of the collar. Features of the accessory 100 which are the same as and/or similar to those of the accessory 10 are designated by the same and/or similar reference numerals.

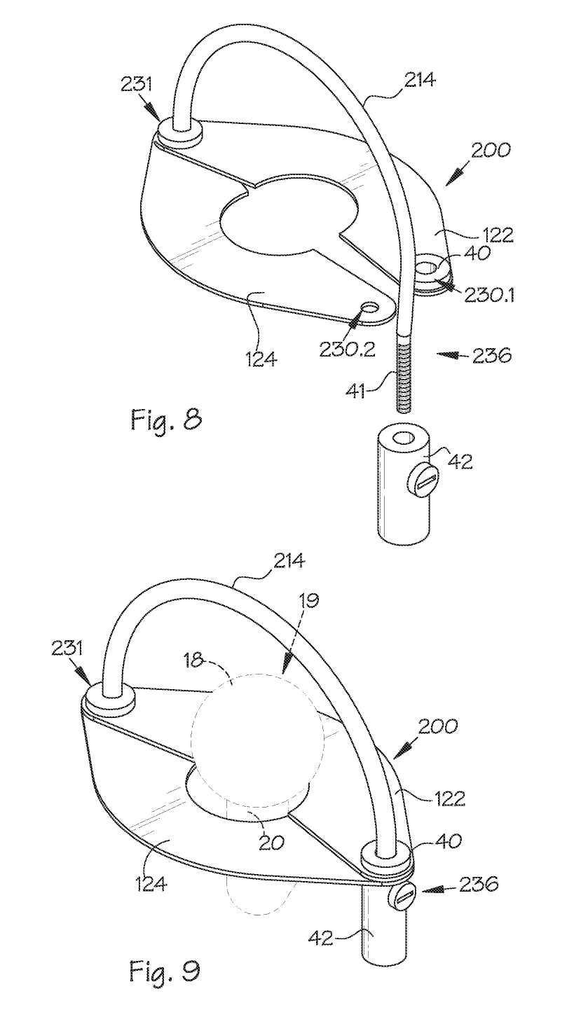

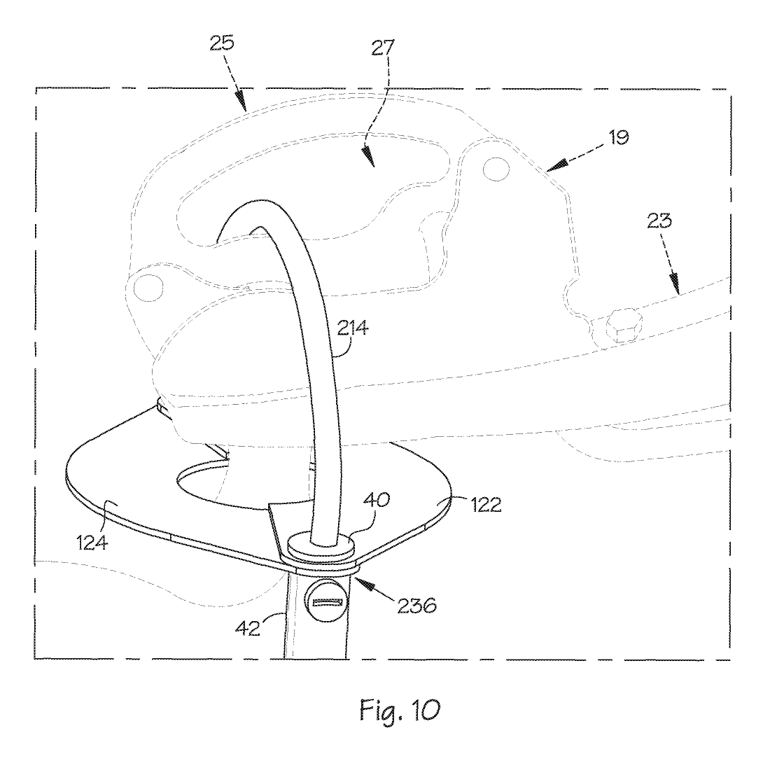

With reference to FIGS. 8 to 10 of the drawings, yet another embodiment of an accessory in accordance with the invention, is designated by the reference numeral 200. The accessory 200 is similar to the accessory 100, with the only difference being that the chain and padlock are replaced by a cable 214 and two-part lock 236. Features of the accessory 200 which are the same as and/or similar to those of the accessory 100 are designated by the same and/or similar reference numerals.

A guide disc 40 is fixedly connected to an outer side of the collar member 122. The guide disc 40 defines an aperture through which the cable 214 can pass. A first part of the lock 236 in the form of a locking pin 41, is fixedly connected to an end of the cable 214 remote from an end 213 thereof which is connected to the collar members. A second part of the lock 236 in the form of a cylinder 42 within which the locking pin is received, is lockable by means of a key to the first part. The cable 214 is received within and extends through the locking apertures 230.1 and 230.2 when aligned. The locking pin 41 defines a number of locking formations which are engaged by locking formations of the cylinder 42 for releasably locking the locking pin to the cylinder. The locking pin is inserted into the cylinder 42 to a depth wherein the cable is pulled taught over the trailer coupler.

1. An accessory for a trailer hitch system comprising a tow hitch of a towing vehicle and a trailer coupler of a trailer for coupling to the tow hitch, the accessory including:
a collar which can be fitted to the neck formation of the tow hitch, the collar including a first collar member and a second collar member which are connectable to one another in a locking configuration of the collar so as to surround the neck formation, the collar members defining an aperture between them when the collar is in its locking configuration, within which the neck formation is received, a cross-sectional width of the aperture being smaller than a cross-sectional width of the ball, thereby preventing the ball from passing through the aperture, the first and second collar members having locking formations for locking the first and second collar members to one another when the collar is in its locking configuration; and
a trailer securing formation which is connected to the collar when the collar is in its locking configuration and securable to the trailer so as to secure the collar and thereby the tow hitch to the trailer.

2. The accessory as claimed in claim 1, wherein the first and second collar members are hingedly connected to one another in an arrangement wherein the collar members are transformable between the locked configuration of the collar and an open configuration of the collar permitting removal of the collar from the neck formation of the tow hitch.

3. The accessory as claimed in claim 1 or claim 2, wherein the collar members are in the form of plate members.

4. The accessory as claimed in any one of claims 1 to 3, wherein the trailer securing formation is in the form of an elongate flexible element.

5. The accessory as claimed in claim 8, wherein one end of the trailer securing formation is fixedly connected to at least one of the collar members.

6. The accessory as claimed in claim 5, wherein the locking formations of the collar members are in the form of locking apertures through which a locking member of a locking device can pass for locking the collar members to one another in the locking configuration of the collar.

7. The accessory as claimed in claim 6, wherein the dimensions and location of the locking apertures are such that when the collar is in its locking configuration, the locking apertures are in register.

8. The accessory as claimed in claim 7, wherein the trailer securing formation includes at least one eye formation which is remote from the one end thereof which is fixedly connected to at least one of the collar members and which can be aligned with the locking apertures of the collar members when the collar is in its locking configuration, thereby permitting the locking formation of a locking device to pass through the locking apertures of the collar members and the eye formation of the trailer securing formation thereby locking the trailer securing formation to the collar members.

9. The accessory as claimed in claim 8, wherein the trailer securing formation is in the form of a chain including loop chain links wherein the links each constitute a particular one of the eye formations.

10. The accessory as claimed in claim 9, wherein the accessory includes a locking device such as a padlock for locking the chain to the collar members.

11. The accessory as claimed in claim 7, wherein the locking formations of the collar members are in the form of locking apertures through which a remote part of the trailer securing formation which is remote from the one end thereof which is fixedly connected to at least one of the collar members, can pass, the dimensions and location of the locking apertures being such that when the collar is in its locking configuration, the locking apertures are in register.

12. The accessory as claimed in claim 11, wherein the accessory includes a two-part locking device, wherein a first part of the locking device is fixedly connected an end of the remote part of the trailer securing formation and a second part of the locking device is releasably lockable to the first part of the locking device in an arrangement wherein the first and second parts of the locking device abut respective outer sides of the collar members for releasably locking the trailer securing formation to the collar members when the remote part of when the trailer securing formation extends through the locking apertures of the collar members.
